(19) United States
(12) Patent Application Publication
(10) Pub. No.: US 2019/0251471 A1
(43) Pub. Date: Aug. 15, 2019

(54) MACHINE LEARNING DEVICE

(71) Applicant: HITACHI, LTD., Tokyo (JP)

(72) Inventors: Kenichi MORITA, Tokyo (JP); Yuki WATANABE, Tokyo (JP); Atsushi HIROIKE, Tokyo (JP); Yoshitaka MURATA, Tokyo (JP); Tsutomu IMADA, Beijing (CN)

(73) Assignee: HITACHI, LTD., Tokyo (JP)

(21) Appl. No.: 16/308,328

(22) PCT Filed: Nov. 1, 2016
(86) PCT No.: PCT/JP2016/082460

§ 371 Date: Dec. 7, 2018

(30) Foreign Application Priority Data
Jun. 16, 2016 (JP) 2016-119599

(51) Int. Cl. G06N 20/00; G06F 16/55; G06F 16/583

(52) U.S. Cl. CPC G06N 20/00; G06F 16/583; G06F 16/55

(57) ABSTRACT

An object is to provide a machine learning device that can reliably and promptly improve image classification accuracy. A machine learning device of the present invention includes: an image database that stores a plurality of images and image features of these images; and a processor that is connected to this image database and that performs machine learning using the plurality of images and the image features stored in the image database, and the processor preferentially selects a predetermined number of images that are images other than images used in past machine learning and that have the low similarities to the images used in the past machine learning, as images used for machine learning from among the images stored in the image database, and performs new machine learning using the selected images.

### FIELD OF THE INVENTION

The present invention relates to a machine learning device.

### BACKGROUND OF THE INVENTION

As an approach for improving image classification accuracy in machine learning, approaches called additional learning and relearning, for example, are known. The additional learning is an approach for performing additional machine learning using machine learning parameters obtained in past machine learning and improving the machine learning parameters. In addition, the relearning is an approach for executing machine learning again.

As an approach for further improving the image classification accuracy using such an approach as the additional learning, an approach for revising training data used in machine learning is known. According to this approach, images that belong to a data aggregate different from a data aggregate of images already used in machine learning are additionally registered in an image database and the additional learning is performed using the images. The improved image classification accuracy can be thereby expected.

### SUMMARY OF THE INVENTION

It is noted herein that it is necessary to additionally register images different from those already included in the image database, in the image database to construct a machine learning device equipped with the approaches described above.

However, incoherently, simply, additionally registering different images in the image database does not mean that the improved image classification accuracy can be expected sufficiently. Even if it is possible to obtain the accuracy to some extent, it is not always possible to effectively improve the image classification accuracy because of the need to add many images.

The present invention has been achieved on the basis of the circumstances described above, and an object of the present invention is to provide a machine learning device that can reliably and promptly improve image classification accuracy.

The present invention relates to

(1) a machine learning device including: an image database that stores a plurality of images and image features of the images; and a processor that is connected to the image database and that performs machine learning using the plurality of images and the image features stored in the image database, in which

the processor

preferentially selects a predetermined number of images that are images other than images used in past machine learning and that have the low similarities to the images used in the past machine learning, as images used for machine learning from among the images stored in the image database, and

performs new machine learning using the selected images,

(2) a machine learning device including: an image database that stores a plurality of images and classification reliabilities of the images; and a processor that is connected to the image database and that performs machine learning using the plurality of images and the classification reliabilities stored in the image database, in which

the processor

preferentially selects a predetermined number of images that have the low classification reliabilities and/or the high classification reliabilities as images used for machine learning from among the images stored in the image database and used in past machine learning, and

performs new machine learning using the selected images, and

(3) a machine learning device including: an image database that stores a plurality of images and image features and classification reliabilities of the images; and a processor that is connected to the image database and that performs machine learning using the plurality of images, the image features, and the classification reliabilities stored in the image database, in which

the processor

preferentially selects a predetermined number of at least one type of images selected from a group configured with images that are images other than images used in past machine learning and that have the low similarities to the images used in the past machine learning, images that are the images used in the past machine learning and that have the low classification reliabilities, and images that are the images used in the past machine learning and that have the high classification reliabilities as images used for machine learning from among the images stored in the image database, and

performs new machine learning using the selected images.

It is noted that the “image” is a concept including image data and still picture data decomposed from video picture data in the present specification and is also called “image data.” The “image features” is a numeric value that is calculated on the basis of the image and that indicates a feature of a specific region in the image. In addition, the “similarity” is a numeric value that is correlated to a distance between the image features of a plurality of images and is, for example, a reciprocal of the distance between the features. Furthermore, the “classification reliability” signifies a likelihood of the machine learning features obtained as a result of image classification. It is noted, however, that the machine learning features refers to information that indicates a content of the image obtained by image classification.

The present invention can provide a machine learning device that can reliably and promptly improve image classification accuracy.

### BRIEF DESCRIPTION OF THE DRAWINGS

FIG. 1 is a schematic block diagram illustrating an embodiment of the present invention;

FIG. 2 is a schematic diagram illustrating an example of a hardware configuration of FIG. 1;

FIG. 3 is a schematic diagram illustrating an example of a configuration of data in an image database of FIG. 1;

FIG. 4 is a schematic flowchart illustrating processes performed when a server computing machine of FIG. 1 performs machine learning;

FIG. 5 is a schematic diagram illustrating an example of a display screen and the like during the processes of FIG. 4;

FIG. 6 is a schematic flowchart illustrating processes for calculating a machine learning features using a machine learning device of FIG. 1;

FIG. 7 is a schematic diagram illustrating an example of a display screen and the like during the processes of FIG. 6;

FIG. 8 is a schematic flowchart illustrating processes for executing additional learning using the machine learning device of FIG. 1; and

FIG. 9 is a schematic diagram illustrating an example of a display screen and the like during the processes of FIG. 8.

### DESCRIPTION OF THE PREFERRED EMBODIMENTS

While an embodiment of a machine learning device according to the present invention will be described hereinafter with reference to the drawings, the present invention is not limited only to the embodiment illustrated in the drawings.

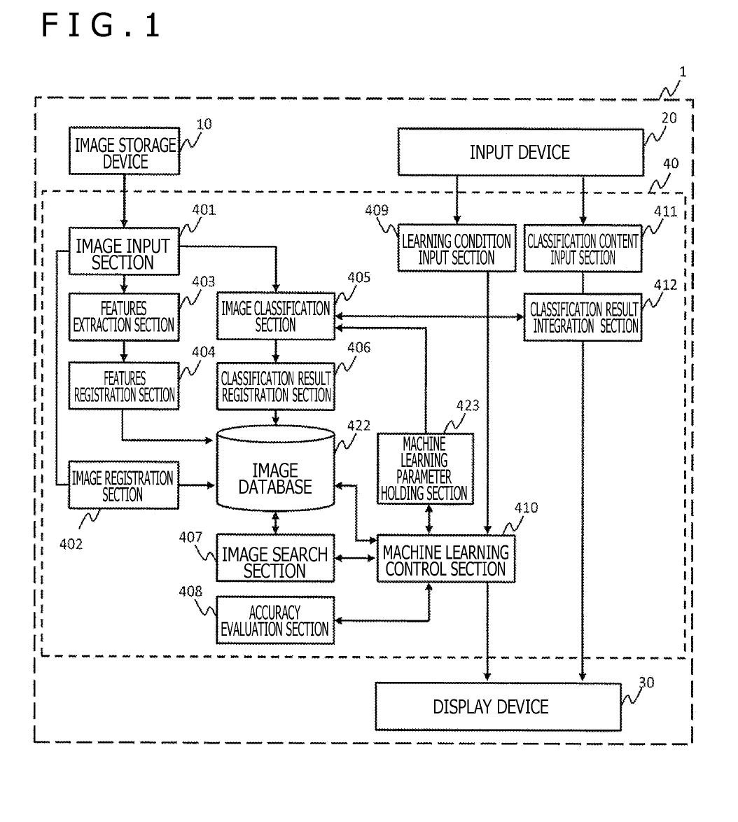

FIG. 1 is a schematic block diagram illustrating the embodiment of the present invention. As depicted in FIG. 1, a machine learning device 1 is schematically configured with an image storage device 10, an input device 20, a display device 30, and a server computing machine 40.

The image storage device 10 is a storage medium that stores image data, video picture data, and the like, and that outputs the data in response to a request. As this image storage device 10, a hard disk drive in which a computer is incorporated, a storage system such as a NAS (Network Attached Storage) or a SAN (Storage Area Network), or the like, for example, can be adopted. In addition, the image storage device 10 may be included in a storage device 42 to be described later. An image or a video picture output from the image storage device 10 is input to an image input section 401, to be described later, in the server computing machine 40 to be described later. It is noted that formats of the image data and the like stored in the image storage device 10 may be arbitrary.

The input device 20 is an input interface for conveying user's operations to the server computing machine 40 to be described later. As this input device 20, a mouse, a keyboard, a touch device, and the like, can be adopted.

The display device 30 displays information about a process condition, a classification result, an operation interactive with a user, and the like of the server computing machine 40. As this display device 30, an output interface such as a liquid crystal display or the like, can be adopted. It is noted that the input device 20 and the display device 30 described above may be integrated using a so-called touch panel or the like.

The server computing machine 40 extracts information contained in each image input from the image storage device 10 on the basis of a preset process condition or a user designated process condition, holds this extracted information as well as the image, identifies a desired image on the basis of a user designated classification condition, assists in annotation of each image stored in an image database 422 on the basis of the process condition, and performs machine learning using data stored in the image database 422.

This server computing machine 40 has the image input section 401, an image registration section 402, a features extraction section 403, a features registration section 404, an image classification section 405, a classification result registration section 406, the image database 422, an image search section 407, an accuracy evaluation section 408, a learning condition input section 409, a machine learning control section 410, a machine learning parameter holding section 423, a classification content input section 411, and a classification result integration section 412.

The image input section 401 reads the image data, the video picture data, or the like from the image storage device 10, and converts the format of this data into a data format used within the server computing machine 40. In a case of reading the video picture data from the image storage device 10, the image input section 401 performs a moving picture decoding process for decomposing a video picture (in a moving picture data format) into frames (in a still picture data format). The image input section 401 sends obtained still picture data (images) to the image registration section 402, the features extraction section 403, and the image classification section 405 to be described later.

The image registration section 402 registers images received from the image input section 401 in the image database 422. The features extraction section 403 extracts a features of each of the images received from the image input section 401. The features registration section 404 registers the features of each image extracted by the features extraction section 403 in the image database 422.

The image classification section 405 reads a machine learning parameter held in the machine learning parameter holding section 423 to be described later, and identifies each image received from the image input section 401 (calculates a machine learning features and a classification reliability of the image) on the basis of the read machine learning parameter. The classification result registration section 406 registers an image classification result of classification performed by the image classification section 405 in the image database 422.

The image database 422 stores a plurality of images and the image features of these images. It is noted that details of the data stored in this image database 422 and the machine learning will be described later.

The classification content input section 411 receives each of the images to be identified input via the input device 20. The classification result integration section 412 sends each of the images to be identified received by the classification content input section 411 to the image classification section 405, acquires the image classification result of classification performed by the image classification section 405, integrates this image classification result with the image to be identified, and sends an integrated result to the display device 30. It is noted that each image to be identified may not be the image input via the input device 20 but an image within the image storage device 10 acquired by way of the image input section 401. In this case, a file path of the image stored in the image storage device 10 is input to the classification content input section 411.

The image search section 407 receives an image to be subjected to a search query (hereinafter, referred to as “query image”) from the machine learning control section 410, and performs a similar image search to the images registered in the image database 422, that is, calculates similarities. A result of the similar image search is sent to the machine learning control section 410.

The accuracy evaluation section 408 receives a correct value of a classification result of the query image and the image classification result of classification performed by the image classification section 405 from the machine learning control section 410, and calculates image classification accuracy using these. It is noted that a data format of the calculated image is converted, by the machine learning control section 410, into a data format suited for display by the display device 30 and the classification accuracy of the calculated image is then displayed on the display device 30.

The learning condition input section 409 receives a machine learning condition input via the input device 20 and sends this machine learning condition to the machine learning control section 410.

The machine learning control section 410 performs machine learning using the images and metadata received from the image database 422 and a similar image search result received from the image search section 407 in accordance with the machine learning condition received from the learning condition input section 409, and controls the accuracy evaluation section 408 to calculate image classification accuracy in a case of using a machine learning parameter obtained by this machine learning. In addition, the machine learning control section 410 controls the accuracy evaluation section 408 to calculate image classification accuracy in a case of using the machine learning parameter held in the machine learning parameter holding section 423. Furthermore, the machine learning control section 410 updates the machine learning parameter held in the machine learning parameter holding section 423 in accordance with the condition received from the learning condition input section 409.

Here, as the server computing machine 40, an ordinary computing machine, for example, can be adopted. As depicted in FIG. 2, hardware of this server computing machine 40 is schematically configured with a storage device 42 and a processor 41. It is noted that the storage device 42 and the processor 41 are connected to the image storage device 10 via a network interface device (NIF) 43 provided in the server computing machine 40.

The storage section 42 has a processing program storage section 421 that stores a processing program for executing each step to be described later, the image database 422 that stores the plurality of images and the image features and/or the classification reliabilities of these images, and the like, and the machine learning parameter holding section 423 that stores the machine learning parameter calculated by the image classification section 405. This storage device 42 can be configured with a storage medium of an arbitrary type and may include, for example, a semiconductor memory and a hard disk drive.

The processor 41 is connected to the storage device 42, reads the processing program stored in the processing program storage section 421, and executes processes (computation) of the sections described above in the server computing machine 40 in accordance with an instruction described in this read processing program. It is noted that this processor 41 performs machine learning using the plurality of images and the image features and/or the classification reliabilities stored in the image database 422. This processor 41 is not limited to a specific one as long as the processor 41 has a central processing unit (CPU) capable of executing the processes and may include a graphics processing unit (GPU) other than the CPU.

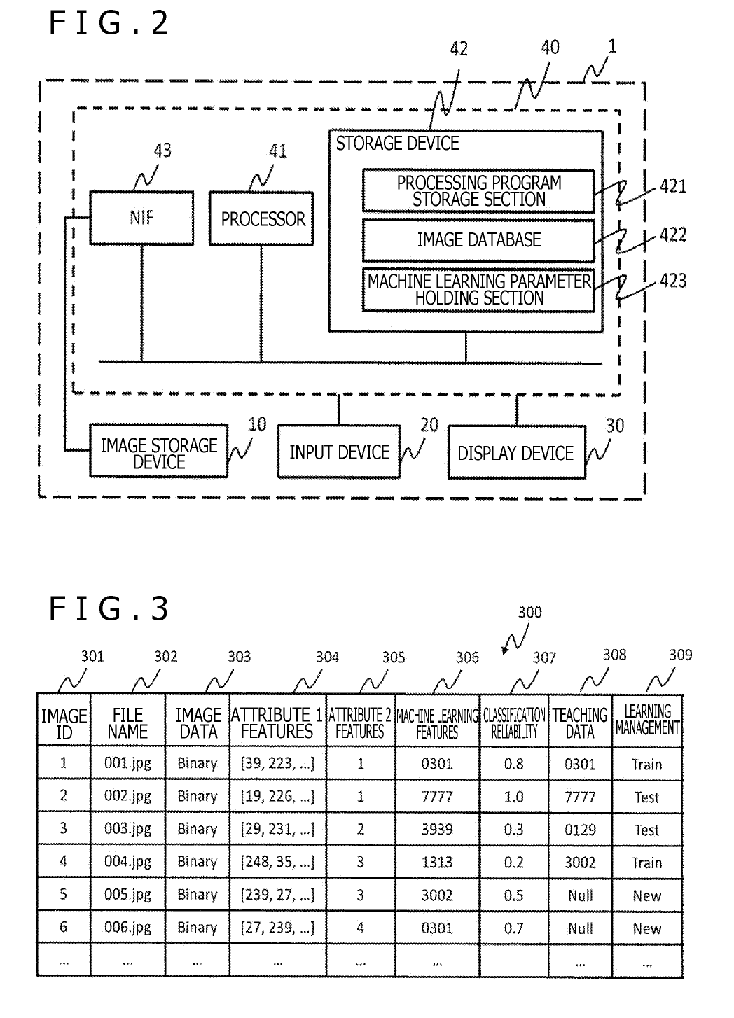

A configuration of the data stored in the image database 422 will next be described. FIG. 3 is a schematic diagram illustrating an example of the configuration of the data in the image database 422 of FIG. 1. The image database 422 includes image data management information 300 depicted in FIG. 3. The configuration of the data in this image data management information 300 is not limited to a specific one as long as the present invention can be carried out, and fields or the like can be added as appropriate in response to, for example, the processing program.

In the present embodiment, the image data management information 300 has image ID fields 301, filename fields 302, image data fields 303, attribute 1 features fields 304, attribute 2 features fields 305, machine learning features fields 306, classification reliability fields 307, teaching data fields 308, and learning management fields 309.

Each image ID field 301 holds classification information (hereinafter, also referred to as “image ID”) about each image data. Each file name field 302 holds a file name of the image data read from the image storage device 10. Each image data field 303 holds the image data read from the image storage device 10 in a binary format.

Each of the attribute 1 features fields 304 and the attribute 2 features fields 305 holds a features of a corresponding type of each image. The features is not limited to a specific one as long as the features can identify each image from among a plurality of images, and may be any of, for example, fixed-length vector data as exemplarily depicted in each attribute 1 features field 304 and scalar data as exemplarily depicted in each attribute 2 features field 305.

Each machine learning features field 306 holds a machine learning features calculated by the image classification section 405. The machine learning features may be either vector data or scalar data. Each classification reliability field 307 holds a classification reliability of the classification result (machine learning features) calculated by the image classification section 405. The classification reliability is, for example, scalar data equal to or greater than 0 and equal to or smaller than 1 as exemplarily depicted in each classification reliability field 307. Each teaching data field 308 holds teaching data. This teaching data may be either vector data or scalar data.

Each learning management field 309 holds management information about a status of application of each image stored in the image database 422 to machine learning. The learning management field 309 is used to record whether the image is data used as, for example, training data or test data in machine learning or data that is not used in past machine learning.

### <Processes in Machine Learning>

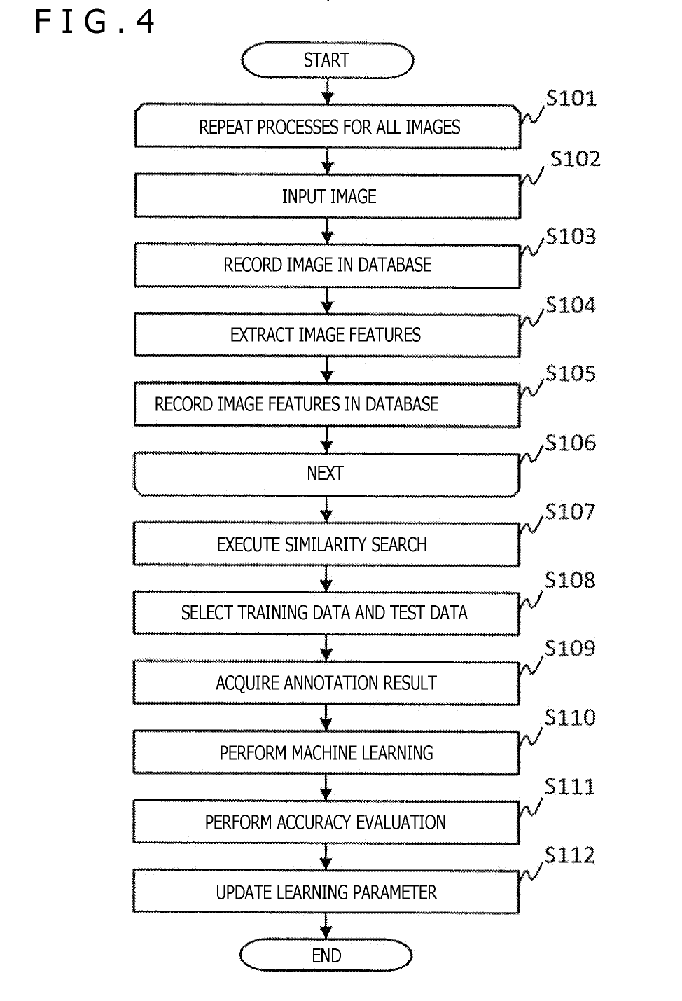

A flow of processes performed by the machine learning device 1 will next be described with reference to FIG. 4. FIG. 4 is a schematic flowchart illustrating processes performed by the server computing machine of FIG. 1 at a time of performing machine learning. The present embodiment illustrates an example of using a deep learning method as a machine learning approach.

First, the image input section 401 in the server computing machine 40 reads image data or the like to be processed from the images stored in the image storage device 10, converts the data format of the image data or the like as appropriate, and acquires an image that can be subjected to various processes (Step S102).

Next, the image registration section 402 registers the image received from the image input section 401 in one image data field 303 of the image data management information 300 in a binary format (Step S103). At this time, the image registration section 402 updates the image ID in the image ID field 301 and records the file name of an image file in the file name field 302.

Next, the features extraction section 403 extracts the image features of the image received from the image input section 401 (Step S104). Next, the features registration section 404 records the features extracted by the features extraction section 403 in the attribute 1 features field 304 of the image data management information 300 (Step S105).

Next, the processes in Steps S102 to S105 described above are repeatedly performed on all the images used in machine learning (Steps S101 and S106). These images used in machine learning may be all of the plurality of images held in the image storage device 10 or may be partial designated images among the plurality of images.

Next, the image search section 407 sets any one of the images registered in the image database 422 as a query image, and performs a similar image search on the other images registered in the image database 422 to calculate similarities (Step S107). As the similarities, the image search section 407 uses, for example, Euclidean distances of the attribute 1 features fields 304 in the image data management information 300. It is noted that the machine learning control section 410 sets each image the obtained similarity of which is equal to or higher than a threshold as a similar image, and records this similarity in the attribute 2 features field 305 of the image data management information 300 as a numeric value or a character string indicating a category.

Next, the machine learning control section 410 selects each image used in machine learning as training data or test data (Step S108). At this time, as depicted in FIG. 3, in a case in which a selected result is, for example, the training data, the machine learning control section 410 records a character string “Train” in the learning management field 309 of the image data management information 300, and in a case in which the selected result is the test data, the machine learning control section 410 records a character string “Test” in the learning management field 309 of the image data management information 300. It is noted that a type of data recorded in the learning management field 309 is not limited to a specific one as long as it is possible to make a distinction between training data and test data, and a numeric value or the like indicating the distinction may be recorded in the learning management field 309.

Next, the machine learning control section 410 executes assisting in user's annotation (Step S109). Specifically, the machine learning control section 410 acquires metadata describing the image selected as the training data or the test data from among the images registered in the image database 422, and records the metadata in the teaching data field 308 of the image data management information 300.

At this time, in a case in which a data file that holds the metadata about the image to be annotated is present in the image storage device 10, the machine learning control section 410 may acquire this data file and record the data in the teaching data field 308 of the image in the image data management information 300.

On the other hand, in a case in which the data file that holds the metadata about the image to be annotated is not present in the image storage device 10, the machine learning control section 410 may control the non-annotated image to be displayed on the display device 30, receive text data or numeric value data input by the user via the input device 20 and describing the image, and record this data in the teaching data field 308 of the image. As for the images identical in the attribute 2 features described above, the machine learning control section 410 may record the identical data in the teaching data fields 308 of the images identical in the attribute 2 features at timing of inputting the data in the teaching data field 308 of any one of the images. It is thereby possible to reduce the number of user's annotations.

While FIG. 3 illustrates an example of recording a numeric value in each teaching data field 308, the data recorded in the teaching data field 308 may be a numeric value vector, a character string, a character string vector, or the like.

Next, the image classification section 405 performs machine learning. First, the image classification section 405 acquires the machine learning parameter held in the machine learning parameter holding section 423 and information associated with the training data in the image data management information 300, and performs this machine learning using the acquired machine learning parameter and the acquired information associated with the training data (Step S110). As the machine learning approach, a well-known technique can be used herein. Examples of the approach include an approach with which the image classification section 405 configures a classifier based on a user designated network model, and calculates an optimum value of a weighting factor in each layer within the network model in such a manner that an output at a time of receiving the image recorded in the image data management information 300 as an input is equal to the value recorded in the teaching data field 308 corresponding to the image ID of the input image. In this case, as a method of calculating the optimum value of the weighting factor, a method of using an error function and obtaining a minimum solution of the error function using a stochastic gradient descent method or the like can be used.

Next, the image classification section 405 calculates the machine learning features of each image in the test data using the user designated network model and the obtained optimum value of the weighting factor, and the accuracy evaluation section 408 calculates the classification accuracy of each image using the calculated machine learning features and teaching data about the image held in the teaching data field 308 (Step S111). This image classification accuracy is displayed on the display device 30 by the machine learning control section 410. It is noted that the “image classification accuracy” means a ratio of the number of pieces of test data that match in the calculated machine learning features and the teaching data held in each teaching data field 308, to the number of all pieces of test data used in machine learning.

Next, the machine learning control section 410 updates the machine learning parameter held in the machine learning parameter holding section 423 to a machine learning parameter used in the machine learning described above (Step S112).

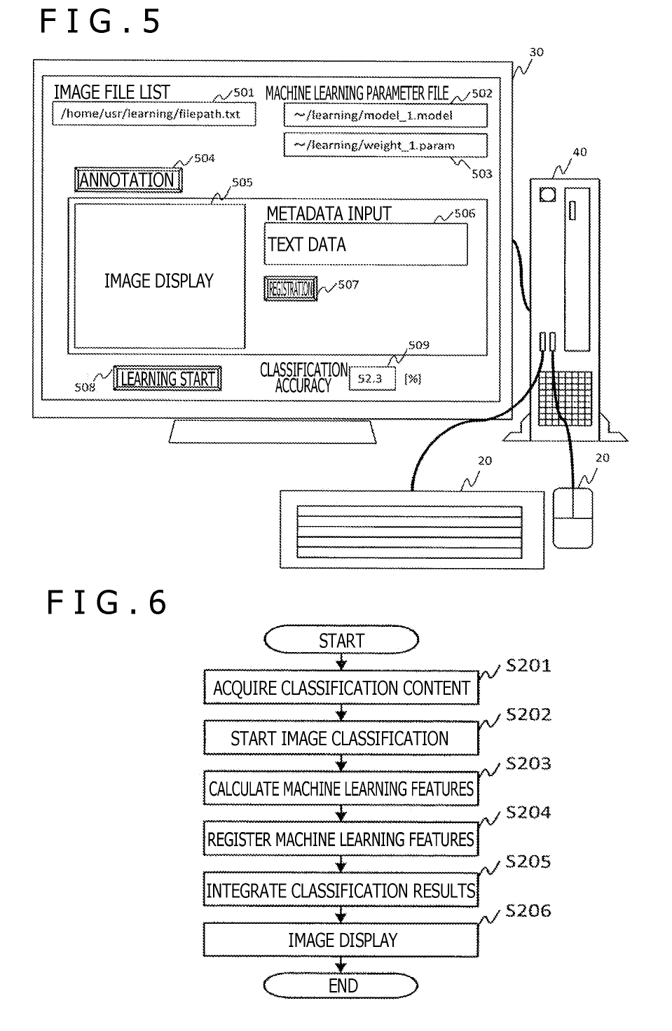

An example of operations on the machine learning performed using the machine learning device 1 will now be described with reference to FIG. 5. FIG. 5 is a schematic diagram illustrating an example of a display screen and the like during the processes of FIG. 4. In FIG. 5, text input fields 501, 502, 503, and 506, an image display section 505, a numeric value display section 509, an annotation start button 504, a metadata registration button 507, and a machine learning start button 508 are included in the display screen of the display device 30.

First, the user inputs a path of a list file that describes paths of a plurality of image files of the images that are held in the image storage device 10 and that act as candidates of training data or text data about the machine learning to the text input field 501 using the keyboard (input device 20). Next, upon completion of input of the path of the list file by, for example, clicking on an Enter key, the processes of FIG. 4 are subsequently started and Step S101 to Step S108 are sequentially executed.

In a case in which the list file is described as a list of vectors configured with the paths of the image files and one or a plurality of metadata describing the images, the image registration section 402 registers both the image data and the metadata in the image database 422 in Step S103. At this time, the metadata is registered in each teaching data field 308 of the image data management information 300. On the other hand, in a case in which the list file is described as a list of the paths of the image files, the metadata is not registered.

Next, an annotation is started in Step S109 by user's clicking on the annotation start button 504 using the mouse (input device 20). At this time, the images with “Null” in the teaching data fields 308 among the images selected as the training data or the test data in Step S108 are sequentially displayed on the image display section 505 and each image awaits a user's annotation.

Next, the user inputs a character string or a digit sequence describing each of the images displayed on the image registration section 505 using the keyboard (input device 20), and clicks on the metadata registration button 507 using the mouse (input device 20), thereby recording the input character string or the like in the teaching data field 308 corresponding to the image ID of each of the images displayed on the image display section 505. The above operations are repeatedly performed on all the training data and the test data necessary to process, thereby completing the annotation (Step S109).

Next, the user inputs paths of machine learning parameter setting files to the text input fields 502 and 503. Specifically, in a case of using, for example, deep learning as machine learning, the path of a file describing the network model is input to the text input field 502 and the path for storing a file describing the weighting factor in each network obtained by the machine learning is input to the text input field 503.

Next, the user clicks on the machine learning start button 508 by the mouse (input device 20), thereby starting machine learning (Step S110). At this time, when the learning condition input section 409 receives the click on the machine learning start button 508 by the mouse (input device 20), the machine learning control section 410 reads, on the basis of the file path input to the text input field 502, a network model file recorded in the machine learning parameter holding section 423 in advance and executes machine learning using the test data and the training data. Next, upon completion of the above machine learning, the image classification accuracy calculated by the accuracy evaluation section 408 is displayed on the numerical value display section 509.

### <Processes in Image Classification>

A flow of processes of image classification (calculation of the machine learning features and the like) performed by the machine learning device 1 after the above machine learning will next be described with reference to FIG. 6. FIG. 6 is a schematic flowchart illustrating the processes for calculating the machine learning features using the machine learning device of FIG. 1.

First, the classification content input section 411 acquires a classification content input by the user via the input device 20 (Step S201). The classification content contains each of the images to be identified and the classification condition. For example, in a case of user's inputting the image file as the image to be identified, a binary value of the input image data serves as the image to be identified. On the other hand, in a case of user's inputting a file path of the image stored in the image storage device 10 as the image to be identified, a binary value of the image read from the image storage device 10 via the image input section 401 serves as the image to be identified.

Next, the classification result integration section 412 sends the image to be identified and the classification condition received from the classification content input section 411 to the image classification section 405 (Step S202). Next, the image classification section 405 acquires the machine learning parameter held in the machine learning parameter holding section 423, and calculates the machine learning features or both the machine learning features and the classification reliability of the acquired image, in accordance with the machine learning parameter and the classification condition (Step S203).

Next, the classification result registration section 406 acquires the file name, the image data, the machine learning features, and the like of the image from the image classification section 405, and records these in the image database 422 (Step S204). It is noted, however, the classification result registration section 406 does not record the file name in a case of acquiring the binary value of the image data, in Step S201.

At the time of recording, the image ID in the image ID field 301 of the image data management information 300 is updated, and the file name, the image data, the machine learning features, and the classification reliability of the image are recorded in the file name field 302, the image data field 303, the machine learning features field 306, and the classification reliability field 307 corresponding to the updated image ID, respectively. It is noted that the classification result registration section 406 may acquire version information about the machine learning parameter, add a new field to the image data management information 300, and record the version information in this field.

Next, the classification result integration section 412 acquires the calculated machine learning features from the image classification section 405 and integrates the acquired machine learning features with the image to be identified to configure a display content (Step S205), and then the display device 30 displays the display content received from the classification result integration section 412 (Step S206).

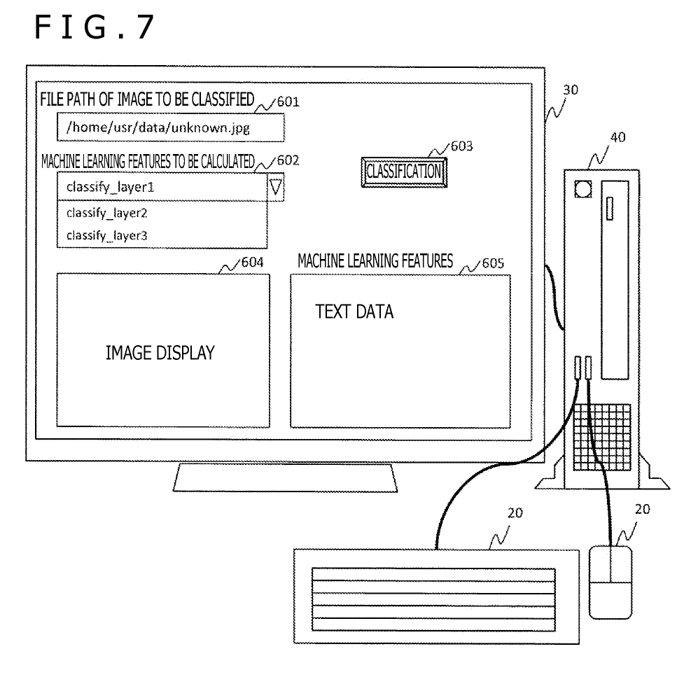

An example of operations on the image classification (calculation of the machine learning features and the like) performed using the machine learning device 1 after the above machine learning will now be described with reference to FIG. 7. FIG. 7 is a schematic diagram illustrating an example of a display screen and the like during the processes of FIG. 6. In FIG. 7, a text input field 601, a drop-down list 602, an image classification start button 603, an image display section 604, and a machine learning features display section 605 are contained in the display screen of the display device 30.

First, the user inputs a file path of the image to be subjected to image classification to the text input field 601. While it is assumed herein that the file of the image to be subjected to image classification is stored in the image storage device 10, an image data paste region may be incorporated on the display screen so that image data itself stored in a storage device other than the image storage device 10, for example, a memory region (so-called clipboard) can be pasted on the paste region.

In addition, a list of types of machine learning features that can be calculated using any of the machine learning parameters is displayed in the drop-down list 602, and the user selects one or more types of machine learning features to be calculated from the list using the mouse (input device 20). It is noted that in this example, a list of types of machine learning features candidates is configured on the basis of the file describing the network model among the machine learning parameter setting files described with reference to FIG. 5.

Next, the user clicks on the image classification start button 603 by the mouse (input device 20) and the classification content input section 411 receives the click on the image classification start button 603 by the mouse. The image having the file path designated in the text input field 601 is then read and the machine learning parameter corresponding to the type of the machine learning features selected in the drop-down list 602 (Step S201), and calculation of the machine learning features is started (Step S202). It is noted that in this example, both the file describing the network model and the file describing the weighting factor in each network updated in the flow of FIG. 4 are read among the machine learning parameter setting files described with reference to FIG. 5.

Next, when the image classification is completed and the machine learning features is calculated, the image for which the machine learning features is to be calculated is displayed on the image display section 604 and the machine learning features is displayed on the machine learning features display section 605. In a use application in which the image classifier performs multiclass classifying using the deep learning, text describing the image may be displayed on the machine learning features display section 605 and a calculation result in an intermediate layer among the image classifier configured with multiple layers may be displayed in a numeric value vector format.

### <Processes in Additional Machine Learning>

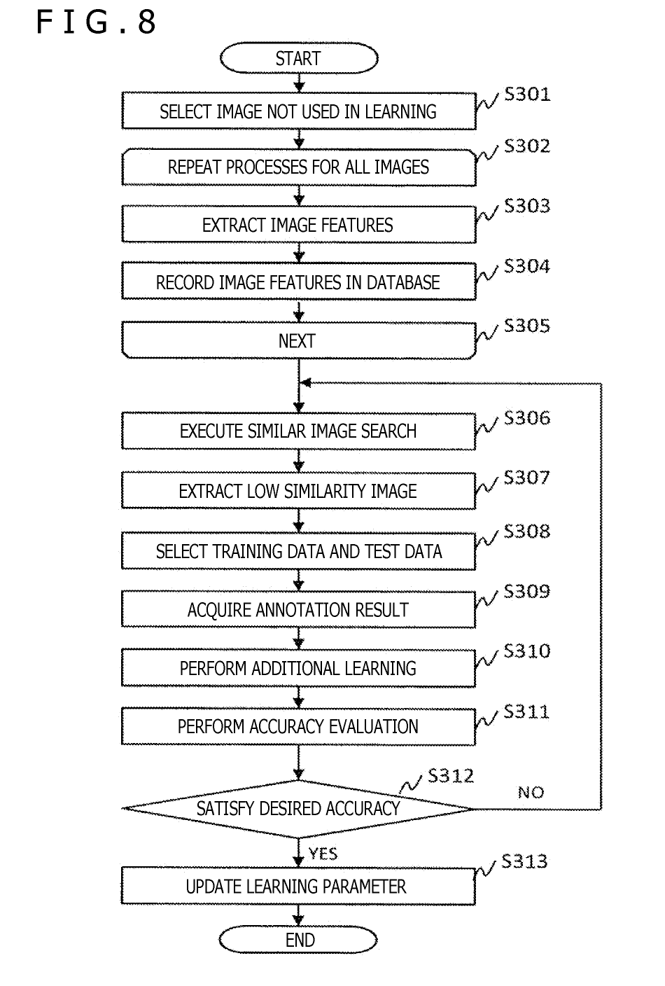

A flow of processes associated with additional machine learning (hereinafter, also referred to as “additional learning”) performed by the machine learning device 1 for the purpose of improving the machine learning parameter will next be described with reference to FIG. 8. FIG. 8 is a schematic flowchart illustrating processes for executing additional learning using the machine learning device of FIG. 1. It is noted that an image, which is not used, used in the present embodiment is an image for which the value in the learning management field 309 is neither “Train” nor “Test.” The image not used is, for example, an image newly and additionally recorded in the image database 422 in image classification performed after previous machine learning.

First, the machine learning control section 410 selects an image not used in machine learning from among the images held in the image database 422 (Step S301). Specifically, the machine learning control section 410 refers to the learning management fields 309 of the image data management information 300, and selects the image IDs of one or two or more images not used in machine learning from the image ID fields 301.

Next, the features extraction section 403 extracts the image features of each of the images selected by the machine learning control section 410 (Step S303), and the features registration section 404 then records the image features in the attribute 1 features field 304 of the image data management information 300 (Step S304). Here, Steps S303 and S304 are repeated until end of processes on all the images selected in Step S301 (Steps S302 and S305). It is noted that the above processes are similar in content to those of Steps S104 and S105.

Next, the image search section 407 sets any one of the images selected in Step S301 as a query image, executes a similar image search to the other images held in the image database 422, and obtains similarities (Step S306). It is noted that a method of performing the similar image search is similar to the method in Step S107 described above. Next, the machine learning control section 410 acquires the similarities obtained by the image search section 407, sets the images each having the similarity equal to or higher than the threshold as a similar image, and records this similarity in the attribute 2 features field 305 of the image data management information 300 as an integer value or a character string indicating a category.

Next, the image search section 407 executes a similar image search to all the images already used in machine learning among the other images held in the image database 422 with any one of the images selected in Step S301 as the query image, and extracts an image having the low similarity from the selected images (Step S307).

Next, the machine learning control section 410 acquires the similarities obtained in Step S306 and the classification reliabilities held in the classification reliability fields 307 of the image data management information 300, and selects training data and test data for additional learning on the basis of the similarities and reliabilities (Step S308).

Processes performed by the machine learning control section 410 for selecting the training data and the test data for additional learning will now be described. The additional learning is generally performed for the purpose of improving the image classification accuracy by machine learning after start of operations for the image classification, and the number of images extracted in Step S301 is normally quite large. Owing to this, it is not easy to execute annotations to all the images. Therefore, for holding the number of user's annotations down to a necessary and sufficient number while enhancing an additional learning effect at the same time, it is effective to perform a process 1, a process 2, a process 3, or a process 4 that is a combination of these processes 1 to 3 by arbitrary weighting to select images (training data and test data). The processes will now be described.

### [Process 1]

The process 1 is a process for preferentially selecting a predetermined number of images that are other than images used in past machine learning and that have the low similarities to the images used in the past machine learning as images used for additional learning (machine learning) from among the images stored in the image database 422. Specifically, in this process 1, the image IDs are sorted in an ascending order of similarities of a similar image search result acquired in Step S307, a preset number of images are extracted from a higher order (images having the low similarities are preferentially extracted), and then a predetermined number of training data is selected from among the extracted images at random. It is noted that the images other than the images selected as the training data among the extracted images are used as test data.

By performing this process 1, the images that belong to a category different from a category of the image data used in machine learning before the additional learning are preferentially used in the additional learning. Therefore, it is possible to efficiently perform the additional learning using the images having the low similarities in a wide range (images greatly different from the images used previously) and reliably and promptly improve the image classification accuracy.

### [Process 2]

The process 2 is a process for preferentially selecting a predetermined number of images that have the high classification reliabilities as images used for additional learning (machine learning) from among the images stored in the image database 422 and used in past machine learning. Specifically, in this process 2, the image IDs are sorted in a descending order of acquired classification reliabilities, a preset number of images are extracted from a higher order, and then a predetermined number of training data is selected from among the extracted images at random. It is noted that the images other than the images selected as the training data among the extracted images are used as test data.

Generally, in a case of the high classification reliability, it is considered that a correct classification result can be calculated without performing additional learning. However, in a case in which image data different in attribute from image data used in machine learning is to be identified, there is a probability that an incorrect classification result is calculated and the classification reliability for the incorrect classification result is high. Owing to this, it is often preferable to execute annotation even for the image data having high classification reliabilities and to include the image data in the training data and the test data in the additional learning. Therefore, by performing the process 2, it is possible to efficiently perform the additional learning using the images having the high classification reliabilities (images that are possibly greatly different from the images used previously) and reliably and promptly improve the image classification accuracy.

### [Process 3]

The process 3 is a process for preferentially selecting a predetermined number of images having the low classification reliabilities as images used for additional learning (machine learning) from among the images stored in the image database 422 and used in past machine learning. Specifically, in this process 3, the image IDs are sorted in an ascending order of acquired classification reliabilities, a preset number of images are extracted from a lower order, and a predetermined number of training data is selected from among the extracted images at random. It is noted that the images other than the images selected as the training data among the extracted images are used as test data.

These images mean images that cannot be identified appropriately using the machine learning parameters obtained in machine learning before the additional learning. Therefore, by performing the process 3, it is possible to efficiently perform the additional learning using the images having the low classification reliabilities (images that are possibly greatly different from the images used previously) and reliably and promptly improve the image classification accuracy.

### [Process 4]

The process 4 is a process for performing a combination of the processes 1 to 3 described above. This process 4 is for preferentially selecting a predetermined number of at least one type of images selected from a group configured with images that are images other than images used in past machine learning and that have the low similarities to the images used in the past machine learning, images that are the images used in the past machine learning and that have the low classification reliabilities, and images that are the images used in the past machine learning and that have the high classification reliabilities as images used for machine learning from among the images stored in the image database 422.

The images used in this process 4 are the images each of which is possibly greatly different from the images used previously, as described in sections of [Process 1] to [Process 3] above. Therefore, it is possible to reliably and promptly improve the image classification accuracy by using these images in the additional learning.

Next, the machine learning control section 410 executes assisting in user's annotation (Step S309). Specifically, the machine learning control section 410 controls each non-annotated image to be displayed one by one on the display device 30 in an arbitrary order among the images selected as the training data or the test data in Step S308, receives text data or numeric value data input by the user via the input device 20 and describing the image, and records this data in the teaching data field 308 of the image. As for the images identical in the attribute 2 features, the machine learning control section 410 records the identical data in the teaching data fields 308 of the images identical in the attribute 2 features at timing of inputting the data. It is thereby possible to reduce the number of user's annotations.

Next, the image classification section 405 acquires the machine learning parameter held in the machine learning parameter holding section 423 and the images (training data) selected in any of [Process 1] to [Process 4] described above, and performs new machine learning (additional learning) using the acquired machine learning parameter and the acquired training data (Step S310). In this additional learning, machine learning is executed using the weighting factor already calculated by the past machine learning as an initial value of the weighting factor in each layer of the network model. It is noted that this process for machine learning is the same as that performed in Step S110 described above.

Next, the accuracy evaluation section 408 acquires the machine learning features for each of the test data identified by the image classification section 405 and the teaching data about the test data held in the image database 422, and calculates the image classification accuracy using the machine learning features and the teaching data (Step S311).

Next, the machine learning control section 410 controls the image classification accuracy obtained by the accuracy evaluation section 408 to be displayed on the display device 30, and determines whether the image classification accuracy satisfies desired accuracy input by the user via the input device 20 (Step S312).

Next, in a case of determining that the image classification accuracy calculated in Step S311 satisfies the desired accuracy, the machine learning control section 410 updates the machine learning parameter held in the machine learning parameter holding section 423 (Step S313). On the other hand, in a case of determining that the image classification accuracy calculated in Step S311 does not satisfy the desired accuracy, Steps S306 to S312 described above are repeatedly executed until the image classification accuracy satisfies the desired accuracy. In this case, selection of the training data and the test data is revised.

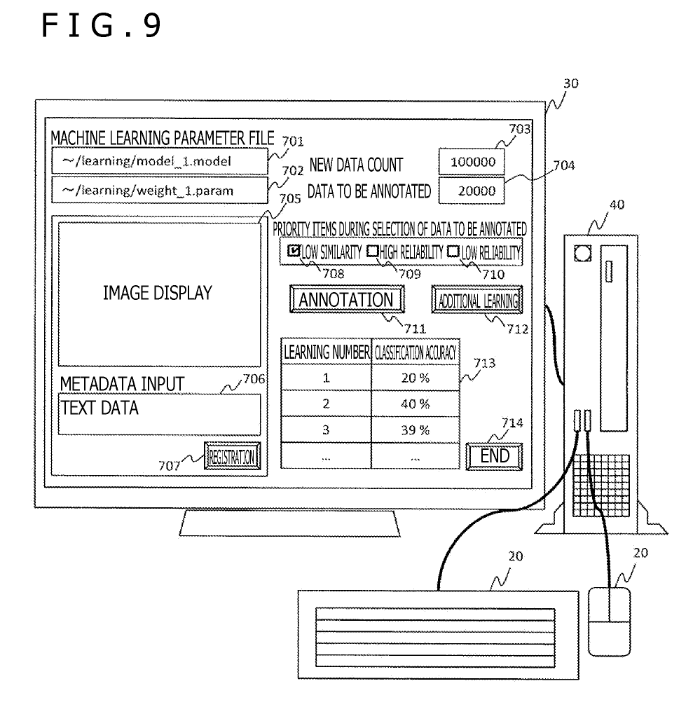

An example of operations on the additional learning performed using the machine learning device 1 will now be described with reference to FIG. 9. FIG. 9 is a schematic diagram illustrating an example of a display screen and the like during the processes of FIG. 8. In FIG. 9, text display sections 701 and 702, text input fields 704 and 706, a numeric value display section 703, an image display section 705, check boxes 708, 709, and 710, a metadata registration button 707, an annotation start button 711, an additional learning start button 712, a classification accuracy display section 713, and an end button 714 are included in the display screen of the display device 30.

The text display sections 701 and 702 display file paths of learned machine learning parameters. In FIG. 9, the machine learning parameters used in deep learning are exemplarily depicted, the path of the file describing the network model is displayed on the text display section 701, and the path of the file describing the weighting factor in each network obtained by the machine learning is displayed on the text display section 702. These paths are file paths of the machine learning parameters used in the flow of image classification described in, for example, the section

### <Process in Image Classification>.

First, when additional learning is started, the machine learning control section 410 displays the number of image data not used in learning on the numerical value display section 703 and displays the same value as the number of image data not used in learning on the text input field 704. At this time, the user can change the numeric value in the text input field 704 using the keyboard (input device 20) or the like and this operation can determine a total number of training data and test data to be annotated (Step S308). It is noted that the numeric value in the text input field 704 depicted in FIG. 9 is a value already changed from an initial numeric value (same value as that displayed on the numerical value display section 703).

Next, the user can change over selection states of the check boxes 708, 709, and 710 using the mouse (input device 20). In these check boxes 708, 709, and 710, one of the processes 1 to 4 described above is selected, and conditions for the selection of the training data and the test data executed in Step S308 are set. It is noted that a plurality of these options can be selected, in which case, it is assumed that weighting is added on the basis of a preset coefficient.

Next, when the user clicks on the annotation start button 711 using the mouse (input device 20), the machine learning control section 410 executes Steps S302 to S308 and then starts Step S309.

Next, the image display section 705 displays each image to be annotated in the Step S309 and the text input field 706 displays data recorded in the teaching data field 308 of the image data management information 300. It is assumed, however, that the text input field 706 is blank in a case in which the data recorded in the teaching data field 308 of the image data management information 300 is “Null.” Alternatively, the data recorded in the machine learning features field 306 is displayed. This data corresponds to a classification value (image classification) identified using the machine learning parameters displayed on the text display sections 701 and 702. In a case in which this text input field 706 is blank or the data is not appropriate as the teaching data, the user can rewrite the data by the keyboard or the like (input device 20).

Next, when the learning condition input section 409 receives the user's click on the registration button 707 by the mouse, the machine learning control section 410 updates the data in the teaching data field 308 to the data in the text input section 706. In this way, the images to be annotated are sequentially displayed on the image display section 705 and the display is repeated until completion of annotation of the training data or the test data selected in Step S308.

Next, when the user clicks on the additional learning start button 712 using the mouse or the like (input device 20), the machine learning control section 410 executes additional learning in Step S310 and then performs accuracy evaluation in Step S311 to calculate the image classification accuracy. An evaluation result of the classification accuracy obtained in Step S311 is displayed, together with a learning number (history of machine learning), on the classification accuracy display section 713. The user can thereby confirm the image classification accuracy displayed on the classification accuracy display section 713, and change the number of data to be annotated in the light of the obtained classification accuracy or re-execute annotation.

Next, the user selects a learning number row displayed on the classification accuracy display section 713, thereby making it possible to determine an additional learning result desired to reflect in the machine learning parameter. Next, when the user clicks on the end button 714 using the mouse (input device 20) and the learning condition input section 409 receives the click, the machine learning control section 410 updates the machine learning parameter file, in which the weighting factor in the network is described, displayed on the text display section 702 to the additional learning result (machine learning parameter) corresponding to the learning number selected in the classification accuracy display section 713, and a series of processes are ended.

As described so far, the machine learning device 1 preferentially selects a predetermined number of images, which are images that are images other than images used in past machine learning and that have the low similarities to the images used in the past machine learning, images that are the images used in the past machine learning and that have the low classification reliabilities, images that are the images used in the past machine learning and that have the high classification reliabilities, or images obtained by a combination of the former images as images used for machine learning, from among the images stored in the image database 422, and performs new machine learning using the selected images. Therefore, it is possible to efficiently perform additional learning using the images greatly different from the images used previously and reliably and promptly improve the image classification accuracy.

It is noted that the present invention is not limited to the configuration of the embodiment described above but is intended to encompass all changes and modifications within the meaning and scope equivalent to those of claims.

For example, while the example of the machine learning device 1 to which the deep learning is applied as the machine learning approach has been illustrated in the embodiment described above, any approach is applicable as long as the approach uses the teaching data. Examples of the machine learning approach using the teaching data that is other than the deep learning include a support vector machine (SVM) and a decision tree.

In addition, while the machine learning device 1 having the image data management information 300 of the specific data configuration as depicted in FIG. 3 has been described in the embodiment described above, the data configuration of the image data management information 300 may be arbitrary as long as the effects of the present invention are not diminished. For example, the data configuration may be selected from among a table, a list, a database, and a queue as appropriate.

Moreover, while the machine learning device 1 calculating the classification reliabilities has been described in the embodiment described above, the machine learning device that does not calculate the classification reliabilities may be used depending on a content of a selection process of the training data or the like for additional learning (for example, the machine learning device that does not perform the processes 2 and 3).

What is claimed is:

1. A machine learning device comprising:
an image database that stores a plurality of images and image features of the images; and
a processor that is connected to the image database and that performs machine learning using the plurality of images and the image features stored in the image database, wherein
the processor
preferentially selects a predetermined number of images that are images other than images used in past machine learning and that have the low similarities to the images used in the past machine learning, as images used for machine learning from among the images stored in the image database, and
performs new machine learning using the selected images.

2. A machine learning device comprising:
an image database that stores a plurality of images and classification reliabilities of the images; and
a processor that is connected to the image database and that performs machine learning using the plurality of images and the classification reliabilities stored in the image database, wherein
the processor
preferentially selects a predetermined number of images that have the low classification reliabilities and/or the high classification reliabilities as images used for machine learning from among the images stored in the image database and used in past machine learning, and
performs new machine learning using the selected images.

3. A machine learning device comprising:
an image database that stores a plurality of images and image features and classification reliabilities of the images; and
a processor that is connected to the image database and that performs machine learning using the plurality of images, the image features, and the classification reliabilities stored in the image database, wherein
the processor
preferentially selects a predetermined number of at least one type of images selected from a group configured with images that are images other than images used in past machine learning and that have the low similarities to the images used in the past machine learning, images that are the images used in the past machine learning and that have the low classification reliabilities, and images that are the images used in the past machine learning and that have the high classification reliabilities as images used for machine learning from among the images stored in the image database, and
performs new machine learning using the selected images.
